(19) United States
(12) Patent Application Publication
(10) Pub. No.: US 2025/0138305 A1
(43) Pub. Date: May 1, 2025

(54) METHOD FOR MACHINING A WORKPIECE BY MEANS OF LASER RADIATION IN THE FORM OF LISSAJOUS FIGURES, SCANNER INTENDED THEREFOR, AND MIRROR ELEMENT

(71) Applicant: LPKF LASER & ELECTRONICS SE, Garbsen (DE)

(72) Inventors: Roman Ostholt, Langenhagen (DE); Norbert Ambrosius, Garbsen (DE); Svenja Schudak, Hannover (DE); Maik Bertke, Hannover (DE); Matthias Hildebrandt, Wunstorf (DE)

(21) Appl. No.: 18/700,285

(22) PCT Filed: Aug. 31, 2022
(86) PCT No.: PCT/EP2022/074227

§ 371 Date: Apr. 11, 2024

(30) Foreign Application Priority Data
Oct. 12, 2021 (DE) 10 2021 126 360.3

(51) Int. Cl. G02B 26/10; B23K 26/0622; B23K 26/082; G02B 26/08

(52) U.S. Cl. CPC G02B 26/101; B23K 26/0624; B23K 26/082; G02B 26/0833

(57) ABSTRACT

A method for processing a workpiece includes directing laser radiation by a micro-electromechanical system (MEMS) scanner onto the workpiece along a processing line in a form of a Lissajous figure, which is variable or static during processing of the workpiece by the laser radiation. A power of the laser radiation is more than 20 W, a pulse length of the laser radiation is between 100 fs and 200 ns, a pulse repetition rate of the laser radiation is more than 200 kHz, a mirror aperture of the MEMS scanner is between 6 mm and 10 mm, a scan frequency of the laser radiation is between 5 kHz and 20 kHz, an angle of incidence of the laser radiation is less than 5° in deviation and a scan angle of the MEMS scanner is less than 2°.

### CROSS REFERENCE TO RELATED APPLICATIONS

This application is a U.S. National Phase application under 35 U.S.C. § 371 of International Application No. PCT/EP2022/074227, filed on Aug. 31, 2022, and claims benefit to German Patent Application No. DE 10 2021 126 360.3, filed on Oct. 12, 2021. The International Application was published in German on Apr. 20, 2023 as WO 2023/061658 A1 under PCT Article 21(2).

### FIELD

The invention relates to a method for processing a workpiece by means of laser radiation which is directed onto the workpiece along a processing line in the form of a Lissajous figure, which in particular is variable or static during the processing. The invention furthermore relates to a scanner, configured in particular as a MEMS scanner, with at least one mirror element, configured in particular as a micromirror, that can be deflected about at least one axis counter to a restoring force of a spring element, wherein at least one mirror element can be deflected by means of electrostatic, electromagnetic, thermal and/or piezoelectric force exertion. The invention furthermore relates to a mirror element for such a scanner.

### BACKGROUND

In principle, the energy of laser radiation is suitable for many processing methods, for example laser cutting of metallic and nonmetallic materials with different material thicknesses. The basis for this is a laser beam that can be guided, shaped and collimated. When it strikes the workpiece, the material is heated so greatly that it melts or vaporizes.

Lasers are in this case distinguished by certain substantial advantages. On the one hand, no mechanical stress is induced in the material owing to the contactless process. On the other hand, accumulation of dust, which could cause malfunctions, is inherently avoided by the method.

For example, a wide variety of FR4 composites may also be processed by laser radiation. The input of thermal energy during the process is controlled in such a way that burning or charring of the material are avoided.

WO 2020/251 782 A1 relates to a method for producing through-holes in workpieces, in particular printed circuit boards, by means of laser radiation and to the division of laser pulses or modulation of the power of laser pulses of a laser source. An acousto-optical deflector (AOD) is used to deflect the beam path and to modify the radiation when it passes through the AOD.

U.S. Pat. No. 10,507,544 B2 relates to a laser processing system with a first positioning system comprising one or more AODs for generating a first relative movement of a beam axis along a beam trajectory in relation to a workpiece, a second positioning system for generating the second relative movement, and a laser source for emitting laser beam pulses which are directed onto individually selected points. The laser beam pulses may also be directed onto spatially identical, overlapping or nonoverlapping regions on the workpiece. According to one embodiment, the positioning systems may be controlled in such a way that the point shape or size of the laser beam can be modified and a plurality of pulses delivered onto the workpiece form a pattern. The AOD may, for example, also be controlled in such a way that the incident laser beam is attenuated.

US 2010/0 140 237 A1 concerns a method for avoiding inaccuracies and quality degradation during laser processing, which result from dynamic and thermal loads of the laser beam positioning and the optical components. For this purpose, for example, an acousto-optical deflector (AOD), an electro-optical deflector (EOD) and a galvanometer scanner cooperate in order to position the laser beam.

In practice, the losses in the acousto-optical or electro-optical deflectors, which may reach up to 50% for ultrashort pulses, have disadvantageous effects. In particular, the imaging quality is degraded in the transmissive deflectors as a result of refraction, so that a reflective element with a highly reflective coating proves superior.

In principle, laser scanners with highly reflective elements are already employed as micro-electromechanical systems (MEMS), for example in the field of metrology, in fingerprint sensors, in barcode scanners or in LIDAR scanners.

The mirrors configured as micro-actuators of the MEMS scanners known from the prior art comprise, for example, an oscillating body with a mirror, which is mounted in such a way as to be capable of oscillating by means of spring elements in a chip frame.

In one typical design, the scanner, which is also known as a gimbal-mounted scanner, has a mirror element which is arranged movably in a second, likewise movably mounted frame.

EP 1 419 411 B1 describes a projection apparatus with a deflecting device for deflecting a light beam about a first and a second deflection axis, in order to move the light beam over the field of view. The light beam is deflected about the first deflection axis with a first deflection frequency and about the second deflection axis with a second deflection frequency. A gimbal-mounted mirror is used as the deflecting device.

Uniaxial and multiaxial mountings are possible, which make it possible to move the movable element linearly (quasi-statically or resonantly), in a grid (one axis quasi-statically, one axis resonantly), in the form of a Lissajous figure (both axes resonantly) or entirely vectorially (both axes quasi-statically).

One advantageous form of operation is based on resonant operation of the MEMS scanner, since in this case a favorable amplification of the mirror oscillation amplitude may be used together with a low energy consumption. This applies for both uniaxial and multiaxial MEMS scanners.

For example, DE 10 2011 104 556 A1 discloses a deflecting apparatus for a scanner with Lissajous scanning having a micromirror oscillating in two deflection axes and driving for resonant operation of the micromirror.

With the coating of the mirrors in the MEMS scanners used in practice, 100% reflectivity is not achieved so that residual radiation is absorbed, which leads to undesired heating of the mirror.

The input of thermal energy induced by the laser may shift the resonant frequency of the MEMS mirror, which causes phase and amplitude changes, and the thermal input may unfavorably be concentrated on the thin torsion springs.

The problem is exacerbated when a fast and a slow axis are combined with one another, because the slow axis is usually produced by a very thin and therefore soft spring mounting that hinders the thermal dissipation.

DE 10 2012 005 546 A1 discloses a MEMS scanner in which a microchannel is provided in order to pass a coolant through a chip frame and the spring elements so as to improve the thermal dissipation of the mirror plate and ensure a high tolerance in relation to the thermal input.

In order to dissipate the heating of the surface of the optical element, which is associated with the incident light, in a mirror arrangement according to DE 10 2007 034 652 A1 it is known to provide a medium for thermal dissipation in a chamber and to cool the chamber walls by means of cooling channels.

Such a cooling arrangement on the elements of the MEMS scanner is expensive to produce, however, and also leads to larger masses and dimensions.

DE 10 2016 111 531 A1 concerns deflection of the electromagnetic beams, which is to be achieved on an optical scanner, in which case the mirror substrate may consist of silicon or quartz glass.

Further, F. Senger, et al., “A 2D circular-scanning piezoelectric MEMS mirror for laser material processing”; IN: Proc. SPIE 11697, MOEMS and Miniaturized Systems XX, 1169704 (5 Mar. 2021); doi: 10.1117/12.2584075 discloses a piezoelectrically driven MEMS scanner. The problem of dynamic deformation occurs in this case, so that a thick silicon layer is used for the mirror plate and the actuators in order to strengthen the mirror plate, to improve the planarity and to increase the stiffness of the actuators, so that a higher frequency is achieved.

### SUMMARY

In an embodiment, the present disclosure provides a method for processing a workpiece. The method includes directing laser radiation by a micro-electromechanical system (MEMS) scanner onto the workpiece along a processing line in a form of a Lissajous figure, which is variable or static during processing of the workpiece by the laser radiation. A power of the laser radiation is more than 20 W, a pulse length of the laser radiation is between 100 fs and 200 ns, a pulse repetition rate of the laser radiation is more than 200 kHz, a mirror aperture of the MEMS scanner is between 6 mm and 10 mm, a scan frequency of the laser radiation is between 5 kHz and 20 kHz, an angle of incidence of the laser radiation is less than 5° in deviation and a scan angle of the MEMS scanner is less than 2°.

### DETAILED DESCRIPTION

Embodiments of the present disclosure provide to achieve particularly efficient laser processing.

In an embodiment, the present invention provides a method for processing a workpiece, in which the beam shape of a Lissajous figure, which in particular is variable or static during the processing, is initially generated by means of at least one glass-based MEMS scanner by resonant oscillatory excitation of two mutually orthogonal axes of the supplied laser radiation. The beam shape of the laser radiation that is generated in this way is subsequently moved over the workpiece by means of at least one further scanner, in particular configured as a galvanometer scanner, so as to carry out the desired processing, for example ablation on the workpiece surface.

The Lissajous figures are generated by two independent resonant axes of at least one MEMS scanner, and the shape of the Lissajous figures is determined by the spacing or the difference of the oscillatory excitation of the resonant axes of the MEMS scanner.

For the laser processing, the mirror of the further scanner is tilted by the assigned actuators in such a way that the processing laser beam, to which the Lissajous figure has previously been imparted, is directed onto the surface of the workpiece. In this way, the beam parameters of the processing laser beam and the intensity distribution of the laser beam spot on the workpiece may be optimally configured, or adapted, for the respective laser processing method and the focal point of the processing laser beam may be moved dynamically with frequencies of between 5 kHz and 20 kHz. At the same time, the laser beam spot is shaped as a processing area delimited by the circumference of the Lissajous figure.

The scan frequency refers to the frequency with which the scanner generates the Lissajous figures. A frequency close to the resonant frequency of the respective oscillating system is preferably used. In a MEMS scanner with two tilt axes, for example, a frequency that lies between the resonant frequencies of the axes is selected. An advantageous frequency range is from 5 to 20 kHz.

The angle of incidence refers to the angle with respect to the surface normal of the mirror element. A small angle of incidence thus means that the radiation strikes the mirror element almost perpendicularly. A small angle of incidence is advantageous since a round laser beam thereby becomes only slightly elliptical.

The scan angle refers to the angle between the emergent direction of the laser radiation after reflection on the mirror element of the scanner mirror in the case of an undeflected mirror element and the emergent direction of the laser radiation in the case of a deflected mirror element. It is preferably less than 2°, since larger angles may lead to an elliptical deformation of the laser beam.

At least one further scanner preferably has as its deflecting device a galvanometer scanner with two mirrors, each of which can be dynamically moved individually by means of drivable galvanometers. In this way, almost any intensity distributions of the beam spot and beam parameter products of the processing laser beam may be provided by means of dynamic beamforming, and in particular Lissajous figures may be described on the workpiece with the laser beam.

Surprisingly, it is found in this case that owing to its highly reflective (HR) coatings, the glass-based MEMS scanner is greatly superior to the acousto-optical deflectors as transmissive deflecting elements. Moreover, it has also been found, however, that glass is much more suitable than silicon. In particular, degradations of the imaging quality may be avoided because the highly reflective coatings are better suited to glass than to silicon and glass as a transmissive basic material does not become heated.

It has also been found that the mechanical properties of glass, contrary to the preconception of persons skilled in the art, mechanically function better than silicon despite its supposed “fragile” properties.

By the recurring, or regular, beam deflection generated by means of the MEMS scanner along closed contour lines in the form of the Lissajous figure, which is deflected onto the workpiece by means of the second scanner, according to an embodiment the present invention high ablation rates together with locally non-excessive input of thermal energy are achieved by the regular beam profile.

In addition, the shape of the Lissajous figure may be modified during operation by adjusting the resonant frequencies of the two axes of the MEMS scanner in relation to one another, and may therefore be adapted to the processing conditions of the workpiece.

Besides a circular shape, almost any Lissajous figures may be generated. Taking into account a stabilization time of only a few periods, the shape of the Lissajous figure and the orientation of the principal axes of the Lissajous figure may thus be adapted to the respective requirements of the processing as desired during operation. The respectively effective processing area as the circumferential contour of the Lissajous figure may thereby be adapted continuously to the progress of the processing, that is to say in particular to the nature, size and orientation of the contour to be processed.

Furthermore, particularly efficient laser processing is achieved according to an embodiment of the present invention by a scanner with a mirror element that has a substrate with a material that is highly transmissive for the wavelength of the radiation used, in particular glass, or consists exclusively of such a material, which is provided with a coating that is highly reflective for the radiation. In a surprisingly simple way, by using a transmissive substrate material, it is thus possible to avoid the undesired heating. In particular, the solution to providing particularly efficient laser processing according to an embodiment of the present invention consists in the use of glass or comparable materials as a transmissive substrate material, which is provided with a highly reflective coating and is used as a mirror in the scanner. The residual radiation occurring as an unreflected component of the radiation is thereby transmitted and therefore passes substantially unimpeded through the transmissive substrate material. The heating of the mirror element and of the further elements of the scanner is thereby effectively reduced.

Particularly advantageously, according to one embodiment of the invention, the substrate only partially has a reflective coating. Such a partially reflective coating is for example applied purposely and restrictedly onto those surface regions that are necessary or expedient for the function of the scanner and the respectively desired deflection ranges. Thus, if the set position, in particular the angle setting of the mirror element, departs from the range useful for the application in question, the radiation, for example laser radiation, does not strike the reflective coating but strikes the substrate material directly or strikes a further coating which is not reflective, or is only very limitedly reflective, and passes through the substrate unimpeded. The radiation used may therefore be employed not only for other applications that require different beam deflection in these regions. Rather, for the first time a series or parallel arrangement of a plurality of scanners may be produced. Furthermore, however, for the first time a substantial improvement of the operational safety when using potentially hazardous radiation may also be achieved by beam deflection outside predefined ranges being prevented since the radiation cannot strike the reflective coating outside the assigned set regions of the mirror elements. Beam deflection outside a predetermined deflection range is therefore prevented even in the event of a malfunction of the control.

Preferably, the radiation that strikes the region excluded from the reflective coating is transmitted through the substrate and, in its further beam path, for example strikes a further scanner. Accordingly, the beam guiding may also be controlled in such a way that a plurality of scanners are arranged successively in the beam path and the scanner on which the radiation respectively impinges may be selected as required.

A further particularly practical embodiment of the present invention is also achieved by a sensor and/or a measuring system, for example so that a rapid check of the radiation intensity of the supplied radiation, for example, may also be carried out during normal operation. Particularly advantageously, the measurement may be carried out without interrupting the scanner operation.

In cases in which further use of the radiation is not intended, it has already proven particularly expedient for at least one surface region to be assigned a deflecting element and/or a beam dump for the transmitted radiation, so that the energy is dissipated not inside the scanner but outside, and without affecting it.

Furthermore, a variant may also be produced in which the substrate has a plurality of coatings, so that for example different radiations can be deflected differently. Of course, not only the coatings in the various regions but also the properties of the substrate may be different. In particular, scanners with different properties for radiations of different wavelengths may thus be produced.

If, according to a further particularly promising embodiment of the invention, the reflective coating is applied as a dielectric coating onto the substrate, it is possible to achieve a very low absorption of the coating and, for example, a reflection of more than 95% with an angle of incidence of +/−5°.

Another likewise particularly expedient embodiment of the invention is also achieved in that the scanner has active and/or passive damping of its mechanical structures, in order to avoid undesired influences that lead to errors.

In practice, a variant of the scanner with two independent resonant axes has also proven to be particularly advantageous.

Furthermore, the particularly efficient laser processing is achieved according to an embodiment of the present invention by a mirror element for a scanner, by the mirror element having a substrate with a material that is highly transmissive for the wavelength of the radiation used, in particular glass, which is provided with a coating that is highly reflective for the radiation, so that the unreflected component of the radiation does not lead to undesired heating of the substrate as in the prior art, but passes substantially unmodified through the substrate. In addition, the transmitted radiation is thereby also available for further application purposes. Optionally, the entire surface of the substrate may be provided with the coating, or only subregions thereof may be provided with it, so that radiation striking the uncoated regions is correspondingly transmitted and usable elsewhere.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for processing a workpiece, the method comprising:
directing laser radiation by a micro-electromechanical system (MEMS) scanner onto the workpiece along a processing line in a form of a Lissajous figure, which is variable or static during processing of the workpiece by the laser radiation,
wherein a power of the laser radiation is more than 20 W, a pulse length of the laser radiation is between 100 fs and 200 ns, a pulse repetition rate of the laser radiation is more than 200 kHz, a mirror aperture of the MEMS scanner is between 6 mm and 10 mm, a scan frequency of the laser radiation is between 5 kHz and 20 kHz, an angle of incidence of the laser radiation is less than 5° in deviation and a scan angle of the MEMS scanner is less than 2°.

2. The method as claimed in claim 1, wherein the Lissajous figure is generated by at least one glass-based MEMS scanner and is moved over the workpiece by at least one further scanner, the Lissajous figure being generated by two independent resonant axes of the MEMS scanner and a shape of the Lissajous figure being determined by a spacing or a difference of excitation frequencies of the axes of the MEMS scanner.

3. The method as claimed in claim 2, wherein at least two Lissajous figures are generated by the MEMS scanner and the at least one further scanner and by a superimposed linear movement of the MEMS scanner and/or the at least one further scanner.

4. The method as claimed in claim 3, wherein at least two of the movements of the MEMS scanner, the further scanner and/or the superimposed linear movement take place independently of one another.

5. The method as claimed in claim 4, wherein precisely three movements of the MEMS scanner and the further scanner take place simultaneously.

6. The method as claimed in claim 4, wherein the movements of the MEMS scanner and the further scanner take place synchronized or unsynchronized.

7. The method as claimed in claim 4, wherein the movements of the MEMS scanner and the further scanner take place in a common plane parallel to the plane of the workpiece.

8. The method as claimed in claim 3, wherein the superimposed movement is generated by one degree of freedom of movement of the MEMS scanner in combination with two degrees of freedom of movement of the further scanner.

9. The method as claimed in claim 8, wherein the two degrees of freedom of movement of the further scanner are generated by one superimposed translational (linear) movement and one rotational movement.

10. The method as claimed in claim 1, wherein the deflection of the laser beam takes place synchronized by means of the at least one MEMS scanner and the at least one further scanner.

11. The method as claimed in claim 1, wherein the laser radiation is deflected by a combination of the MEMS scanner and at least one galvanometer scanner.

12. A micro-electromechanical system (MEMS) scanner configured to carry out the method as claimed in claim 1, the MEMS scanner comprising:
at least one mirror element that is deflectable about at least one axis counter to a restoring force of a spring element,
wherein the at least one mirror element has a substrate made of a material that is highly transmissive for a wavelength of the laser radiation used, with at least one coating that is reflective for the radiation.

13. The MEMS scanner as claimed in claim 12, wherein the reflective coating is highly reflective for radiation with particular properties, and has a low reflectivity for radiation with other properties.

14. The MEMS scanner as claimed in claim 12, further comprising at least one further mirror element, wherein the laser radiation transmitted by the at least one mirror element strikes the at least one further mirror element.

15. The MEMS scanner as claimed in claim 12, wherein the reflective coating is a dielectric coating.

16. The MEMS scanner as claimed in claim 12, wherein the reflective coating has a reflectance of more than 95%.

17. The MEMS scanner as claimed in claim 12, further comprising mechanical structures to which active and/or passive damping is assigned, wherein the MEMS scanner has active damping.

18. The MEMS scanner as claimed in claim 12, further comprising a purge for nitrogen.

19. The MEMS scanner as claimed in claim 14, wherein the at least one mirror element and/or the at least one further mirror element is/are movable about two independent resonant axes.

20. The MEMS scanner as claimed in claim 12, further comprising at least one galvanometer scanner.

21. A mirror element for the MEMS scanner as claimed in claim 12 wherein the mirror element has a substrate with a material that is highly transmissive for the wavelength of the radiation used, with a coating that is highly reflective for the laser radiation.
